(19) United States
(12) Patent Application Publication
(10) Pub. No.: US 2024/0166369 A1
(43) Pub. Date: May 23, 2024

(54) VEHICLE OPERATION ASSIST SYSTEM

(71) Applicant: KABUSHIKI KAISHA TOYOTA JIDOSHOKKI, Aichi (JP)

(72) Inventors: Shunsuke SASAKI, Aichi (JP); Fumihiro FUKATSU, Aichi (JP)

(73) Assignee: KABUSHIKI KAISHA TOYOTA JIDOSHOKKI, Aichi (JP)

(21) Appl. No.: 18/508,659

(22) Filed: Nov. 14, 2023

(30) Foreign Application Priority Data
Nov. 18, 2022 (JP) 2022-185181

(51) Int. Cl. B64F 1/32; B62D 53/06

(52) U.S. Cl. CPC B64F 1/32; B62D 53/067

(57) ABSTRACT

A vehicle operation assist system includes a plurality of detection devices provided in an airport, and a grasping device provided in a towing tractor or a management device that manages an operation of a towing tractor. The detection devices include an outside sensor, a detection unit, and a detection-side communication unit. The grasping device includes a grasping unit and a grasping-side communication unit. The detection unit is configured to discriminate a high-speed vehicle as a type of an object. The grasping unit grasps a position of the high-speed vehicle in the airport from a position of the outside sensor in the airport and a detection result of the detection unit.

### CROSS-REFERENCE TO RELATED APPLICATION

This application claims priority to Japanese Patent Application No. 2022-185181 filed on Nov. 18, 2022, the entire disclosure of which is incorporated herein by reference.

### BACKGROUND ART

The present disclosure relates to a vehicle operation assist system for use in an airport.

A plurality of types of vehicles are used in airports. Known vehicles used in airports include towing tractors. The towing tractor transports a container by traveling while towing a dolly on which the container is placed. Therefore, the vehicle length of the towing tractor tends to be long. As described in Japanese Patent No. 6891787, a vehicle sensor is mounted on the towing tractor. The detection result of the vehicle sensor is used to grasp the presence or absence of an obstacle around the towing tractor. Known vehicle used in airports also include buses for transporting passengers of airplanes between the passenger terminal and the airport apron and food loaders for transporting airline meals.

The speed limit of vehicles in the airport is set for each airport. The speed limit of vehicles in the airport varies depending on the type of vehicle. For example, the speed limit of the towing tractor is 15 km/h. The speed limit of the bus or the food loader is 30 km/h. Thus, the bus and the food loader are high-speed vehicles having the speed limit set to a speed higher than the speed limit of the towing tractor.

Although the towing tractor is mounted with a vehicle sensor, the detection range of the vehicle sensor may have a blind spot when a parked vehicle or a structure is present around the towing tractor. In this case, the presence or absence of an obstacle cannot be grasped in a range of the blind spot of the vehicle sensor in the surroundings of the towing tractor.

In airports where the towing tractor and the high-speed vehicle are mixedly present, it is preferable to prioritize the operation of the high-speed vehicle over the operation of the towing tractor in order to achieve the punctual operation of the high-speed vehicle. In order to prioritize the operation of the high-speed vehicle over the operation of the towing tractor, it is necessary to grasp the positional relationship between the towing tractor and the high-speed vehicle.

The present disclosure, which has been made in light of the above-mentioned problem, is directed to providing a vehicle operation assist system that reliably grasps the presence or absence of the obstacle around the towing tractor and grasps the positional relationship between the towing tractor and the high-speed vehicle.

### SUMMARY

In accordance with an aspect of the present disclosure, there is provided a vehicle operation assist system for use in an airport where a towing tractor mounted with a vehicle sensor and a high-speed vehicle that is a vehicle having a speed limit set to be higher than a speed limit of the towing tractor operate. The vehicle operation assist system includes a plurality of detection devices provided in the airport, and a grasping device provided in the towing tractor or a management device that manages an operation of the towing tractor. The detection devices include an outside sensor, a detection unit, and a detection-side communication unit. The outside sensor is provided outside the towing tractor and installed such that a detection passage including an operation passage where the towing tractor and the high-speed vehicle operate and side strips provided on both sides of the operation passage is included in a detection range. The detection unit detects a type of an object present in the detection passage and a position of the object in the detection range of the outside sensor based on a detection result of the outside sensor. The detection-side communication unit is configured to transmit a detection result of the detection unit to the grasping device. The grasping device includes a grasping unit and a grasping-side communication unit. The grasping unit grasps a position of the towing tractor in the airport and grasps presence or absence of an obstacle around the towing tractor based on the detection result of the vehicle sensor. The grasping-side communication unit is configured to receive the detection result of the detection unit transmitted from the detection-side communication unit. The detection unit is configured to discriminate the high-speed vehicle as the type of the object, and the grasping unit grasps a position of the high-speed vehicle in the airport from a position of the outside sensor in the airport and the detection result of the detection unit.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic diagram illustrating an example of an airport passage;

FIG. 2 is a block diagram illustrating a configuration of a vehicle operation assist system according to an embodiment;

FIG. 3 is a schematic diagram for describing processing of the vehicle operation assist system according to the embodiment;

FIG. 4 is a schematic diagram for describing processing of the vehicle operation assist system according to the embodiment;

FIG. 5 is a schematic diagram for describing processing of the vehicle operation assist system according to the embodiment;

FIG. 6 is a schematic diagram for describing processing of the vehicle operation assist system according to the embodiment;

FIG. 7 is a block diagram illustrating a configuration of a vehicle operation assist system according to a modification; and

FIG. 8 is a block diagram illustrating a configuration of a vehicle operation assist system according to a modification.

### DETAILED DESCRIPTION OF THE EMBODIMENTS

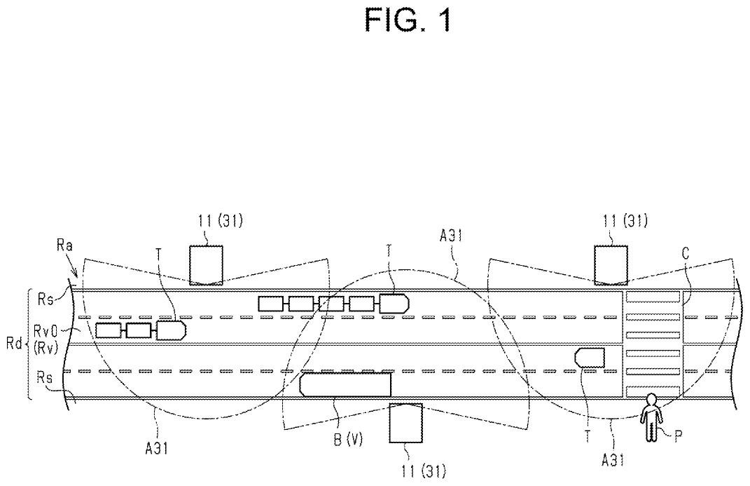

Hereinafter, an embodiment embodying the vehicle operation assist system will be described with reference to FIGS. 1 to 6. The vehicle operation assist system is for use in an airport.

As illustrated in FIG. 1, a towing tractor T is used at an airport. The towing tractor T is a vehicle that transports a container by traveling while towing a dolly on which the container is placed. Therefore, the vehicle length of the towing tractor T tends to be long. The towing tractor T of the present embodiment is an unmanned driving vehicle. A bus B, a food loader not illustrated, and the like are used in the airport. The bus B is a vehicle that transports passengers of an airplane between the passenger terminal and the airport apron. The food loader is a vehicle that transports airline meals. The bus B and the food loader are manned driving vehicles.

An airport passage Ra includes a vehicle passage Rv and side strips Rs. The vehicle passage Rv is a passage where vehicles pass. The vehicle passage Rv of the present embodiment is a passage having two lanes of a forward passage and two lanes of a backward passage. The side strips Rs are provided on both sides of the vehicle passage Rv. The airport passage Ra of the airport is provided with a pedestrian crossing C. A person P such as a worker crosses the vehicle passage Rv by passing through the pedestrian crossing C.

The speed limit of the vehicle in the vehicle passage Rv is determined for each airport. The speed limit of the vehicle in the vehicle passage Rv varies depending on the type of the vehicle. For example, the speed limit of the towing tractor T is set to 15 km/h. The speed limit of the bus B or the food loader is set to km/h. Therefore, the bus B and the food loader are high-speed vehicles V having the speed limit set to a speed higher than the speed limit of the towing tractor T.

In the airport, as described above, the vehicle operation is performed in a state where a plurality of types of vehicles having different traveling speeds and vehicle lengths are mixedly present. Hereinafter, in the vehicle passage Rv, a passage where both the towing tractor T and the high-speed vehicle V operate is referred to as an operation passage Rv0. The operation passage Rv0 and the side strips Rs positioned on the both sides of the operation passage Rv0 are referred to as a detection passage Rd.

### Towing Tractor

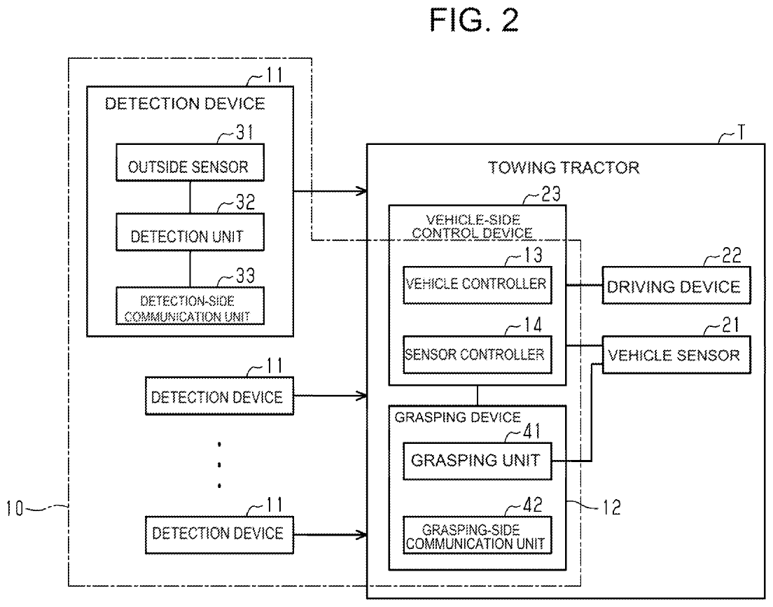

As illustrated in FIG. 2, the towing tractor T includes a vehicle sensor 21, a driving device 22, and a vehicle-side control device 23.

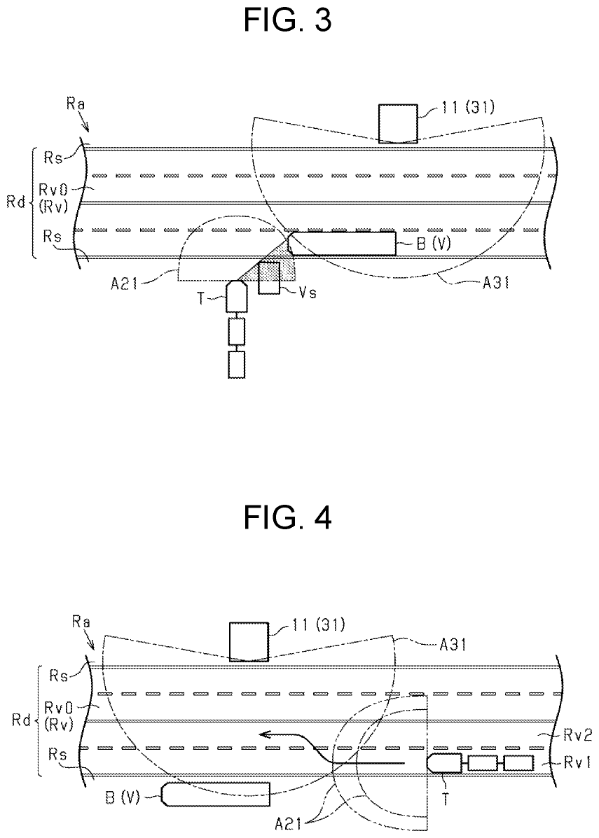

The vehicle sensor 21 is mounted on the towing tractor T. The vehicle sensor 21 is used to grasp the presence or absence of an obstacle around the towing tractor T. The vehicle sensor 21 of the present embodiment is a laser imaging detection and ranging (LIDAR). The LIDAR irradiates the surroundings with a laser. The LIDAR receives reflected light reflected by a portion hit by the laser. The LIDAR is a distance meter that can recognize a surrounding environment. The vehicle 20 sensor 21 is a two-dimensional distance meter that emits a laser while changing the irradiation angle in the horizontal direction. In the present embodiment, the vehicle sensor 21 is configured to be able to change a detection range A21 (see FIG. 3).

The driving device 22 causes the towing tractor T to perform a traveling operation. The driving device 22 rotationally drives wheels not illustrated of the towing tractor T and changes a steering angle (traveling direction). For example, when the towing tractor T is of an engine type, the driving device 22 includes an engine and a steering device that changes the operation angle. For example, when the towing tractor T is of an EV type having a power storage device, the driving device 22 includes an electric motor and a steering device that rotationally drive wheels.

The vehicle-side control device 23 includes a processor and a storage unit. As the processor, for example, a central processing unit (CPU), a graphics processing unit (GPU), or a digital signal processor (DSP) is used. The storage unit includes a random access memory (RAM) and a read only memory (ROM). The storage unit stores a program for operating the towing tractor T. The storage unit stores a program code or a command configured to cause the processor to execute processing. The storage unit, that is, a computer-readable medium includes any available media that can be accessed by a general-purpose or dedicated computer. The vehicle-side control device 23 may be configured by a hardware circuit such as an application specific integrated circuit (ASIC) or a field programmable gate array (FPGA). The vehicle-side control device 23, which is a processing circuit, can include one or more processors that operate in accordance with a computer program, one or more hardware circuits such as an ASIC and an FPGA, or a combination thereof. The vehicle-side control device 23 is connected to the vehicle sensor 21 and the driving device 22.

### Configuration of Vehicle Operation Assist System

A vehicle operation assist system 10 includes a plurality of detection devices 11 and a grasping device 12. The plurality of detection devices 11 are provided in the airport. The grasping device 12 of the present embodiment is provided in the towing tractor T.

The detection device 11 includes an outside sensor 31, a detection unit 32, and a detection-side communication unit 33.

The outside sensor 31 of the present embodiment is provided outside the towing tractor T, and a laser imaging detection and ranging (LIDAR). The outside sensor 31 is a three-dimensional distance meter that emits a laser while changing the irradiation angles in both the horizontal direction and the vertical direction. As illustrated in FIG. 3, a detection range A31 of the outside sensor 31 is wider than the detection range A21 of the vehicle sensor 21.

As illustrated in FIG. 1, each of the detection devices 11 is installed such that the detection range A31 of the outside sensor 31 includes the detection passage Rd. The detection devices 11 are installed in the side strips Rs of the detection passage Rd, for example. The plurality of detection devices 11 are alternately installed in the side strip Rs positioned on one end side of the operation passage Rv0 and the side strip Rs positioned on the other end side of the operation passage Rv0. The plurality of detection devices 11 are installed at intervals along the detection passage Rd. The plurality of detection devices 11 are installed such that parts of the detection ranges A31 of the outside sensors 31 of the adjacent detection devices 11 overlap. Among the plurality of detection devices 11, some detection devices 11 are installed such that the detection range A31 of the outside sensor 31 includes the pedestrian crossing C.

The detection unit 32 includes a processor and a storage unit. As the processor, for example, a central processing unit (CPU), a graphics processing unit (GPU), or a digital signal processor (DSP) is used. The storage unit includes a random access memory (RAM) and a read only memory (ROM). The storage unit stores a program for operating the detection device 11. The storage unit stores a program code or a command configured to cause the processor to execute processing. The storage unit, that is, a computer-readable medium includes any available media that can be accessed by a general-purpose or dedicated computer. The detection unit 32 may be configured by a hardware circuit such as an application specific integrated circuit (ASIC) or a field programmable gate array (FPGA). The detection unit 32, which is a processing circuit, can include one or more processors that operate in accordance with a computer program, one or more hardware circuits such as an ASIC and an FPGA, or a combination thereof.

As illustrated in FIG. 2, the detection unit 32 is connected to the outside sensor 31. The detection unit 32 detects the presence or absence of an object in the detection passage Rd based on a detection result of the outside sensor 31. Upon detecting an object in the detection passage Rd, the detection unit 32 detects the position of the detected object. The detection unit 32 detects the position of the object in the detection range A31 of the outside sensor 31 as the position of the object in the detection passage Rd. The detection unit 32 discriminates the type of the detected object. Specifically, the detection unit 32 stores shapes and sizes of a plurality of types of objects in advance. The detection unit 32 detects the shape and size of the object in the detection passage Rd from the detection result of the outside sensor 31. The detection unit 32 discriminates the type of the object in the detection passage Rd from the shapes and sizes of the stored objects and the shape and size of the detected object. The detection unit 32 is configured to be able to discriminate the high-speed vehicle V as the type of the object. In the present embodiment, the detection unit 32 of the detection device 11 with the detection range A31 of the outside sensor 31 including the pedestrian crossing C is configured to be able to discriminate the person P as the type of the object. In the present embodiment, the detection unit 32 is configured to be able to discriminate a construction vehicle Vc as the type of the object.

The detection-side communication unit 33 is communication equipment communicable by an arbitrary wireless communication method. The wireless communication method is, for example, a wireless LAN, Zigbee (registered trademark), low power wide area (LPWA), or a mobile communication system. The detection-side communication unit 33 can transmit and receive a radio signal. The detection-side communication unit 33 can communicate with the grasping device 12.

The detection device 11 transmits the detection result of the detection unit 32 to the grasping device 12 via the detection-side communication unit 33. The detection result of the detection unit 32 includes the type of the object and the position of the object in the detection range A31 of the outside sensor 31.

The grasping device 12 includes a grasping unit 41 and a grasping-side communication unit 42.

The grasping unit 41 includes a processor and a storage unit. As the processor, for example, a central processing unit (CPU), a graphics processing unit (GPU), or a digital signal processor (DSP) is used. The storage unit includes a random access memory (RAM) and a read only memory (ROM). The storage unit stores a program for operating the grasping device 12. The storage unit stores a program code or a command configured to cause the processor to execute processing. The storage unit, that is, a computer-readable medium includes any available media that can be accessed by a general-purpose or dedicated computer. The grasping unit 41 may be configured by a hardware circuit such as an application specific integrated circuit (ASIC) or a field programmable gate array (FPGA). The grasping unit 41, which is a processing circuit, can include one or more processors that operate in accordance with a computer program, one or more hardware circuits such as an ASIC and an FPGA, or a combination thereof.

The grasping-side communication unit 42 is a communication unit similar to the detection-side communication unit 33. The grasping-side communication unit 42 can communicate with the detection device 11. The grasping device 12 receives the detection result of the detection unit 32 from the detection device 11 via the grasping-side communication unit 42.

The grasping unit 41 grasps the presence or absence of an obstacle around the towing tractor T. The grasping unit 41 is connected to the vehicle sensor 21. The grasping unit 41 grasps the presence or absence of an obstacle around the towing tractor T based on the detection result of the vehicle sensor 21. The detection range A21 of the vehicle sensor 21 may have a blind spot, details of which will be described later. In this case, the grasping unit 41 grasps the presence or absence of an obstacle by using the detection result of the detection unit 32 for a range of the blind spot of the detection range A21 of the vehicle sensor 21 in the surroundings of the towing tractor T.

The grasping unit 41 grasps the position of the towing tractor T in the airport. In the present embodiment, as the position of the towing tractor T in the airport, the grasping unit 41 grasps the position of the towing tractor T mounted with the grasping device 12. The grasping unit 41 grasps the position of the towing tractor T in the airport using a global positioning system (GPS), for example. The grasping unit 41 may grasp the position of the towing tractor T in the airport using a method other than the GPS.

The grasping unit 41 grasps the position of the high-speed vehicle V in the airport based on the detection result of the detection unit 32. As described above, the detection result of the detection unit 32 includes the type of the object and the position of the object in the detection range A31 of the outside sensor 31. Therefore, the grasping unit 41 grasps that the object in the detection passage Rd is the high-speed vehicle V from the type of the object discriminated by the detection unit 32. The grasping unit 41 stores the position of the outside sensor 31 of each of the detection devices 11 in the airport. The grasping unit 41 grasps the position of the high-speed vehicle V in the airport from the position of the outside sensor 31 in the airport and the position of the object in the detection range A31 of the outside sensor 31.

Similarly, the grasping unit 41 of the present embodiment grasps the position of the person P in the airport based on the detection result of the detection unit 32. The grasping unit 41 grasps that the object in the detection passage Rd is the person P from the type of the object discriminated by the detection unit 32. The grasping unit 41 grasps the position of the person P in the airport from the position of the outside sensor 31 in the airport and the position of the object in the detection range A31 of the outside sensor 31.

Similarly, the grasping unit 41 of the present embodiment grasps the position of the construction vehicle Vc in the airport based on the detection result of the detection unit 32. The grasping unit 41 grasps that the object in the detection passage Rd is the construction vehicle Vc from the type of the object discriminated by the detection unit 32. The grasping unit 41 grasps the position of the construction vehicle Vc in the airport from the position of the outside sensor 31 in the airport and the position of the construction vehicle Vc in the detection range A31 of the outside sensor 31.

The vehicle operation assist system 10 of the present embodiment includes a vehicle controller 13. In the present embodiment, the vehicle controller 13 is provided in the vehicle-side control device 23 of the towing tractor T. The vehicle controller 13 performs control related to travel of the towing tractor T. Specifically, the vehicle controller 13 sets the traveling speed of the towing tractor T. The vehicle controller 13 controls the driving device 22 so that the towing tractor T travels at a set speed. The vehicle controller 13 selects the traveling lane of the towing tractor T. The vehicle controller 13 controls the driving device 22 so that the towing tractor T travels in the selected lane.

The vehicle controller 13 sets the traveling speed of the towing tractor T based on the presence or absence of an obstacle around the towing tractor T grasped by the grasping unit 41. The vehicle controller 13 sets the traveling speed of the towing tractor T and selects the traveling lane of the towing tractor T based on the positions of the towing tractor T and the high-speed vehicle V in the airport grasped by the grasping unit 41. The vehicle controller 13 sets the traveling speed of the towing tractor T based on the positions of the towing tractor T and the person P in the airport grasped by the grasping unit 41. The vehicle controller 13 selects the traveling lane of the towing tractor T based on the positions of the towing tractor T and the construction vehicle Vc in the airport grasped by the grasping unit 41.

The vehicle operation assist system 10 of the present embodiment includes a sensor controller 14. In the present embodiment, the sensor controller 14 is provided in the vehicle-side control device 23 of the towing tractor T. The sensor controller 14 performs control related to the vehicle sensor 21. Specifically, the sensor controller 14 sets the detection range A21 of the vehicle sensor 21. The vehicle sensor 21 performs detection in the detection range A21 set by the sensor controller 14. The sensor controller 14 sets the detection range A21 of the vehicle sensor 21 based on the positions of the towing tractor T and the high-speed vehicle V in the airport grasped by the grasping unit 41.

### Processing of Vehicle Operation Assist System

Processing performed by the vehicle operation assist system 10 will be described with reference to specific examples illustrated in FIGS. 3 to 6. In the following specific examples, the processing performed by the vehicle controller 13 and the sensor controller 14 is an example.

For example, as illustrated in FIG. 3, the towing tractor T is positioned outside the detection passage Rd when not transporting the container. Then, when transporting the container, the towing tractor T enters the operation passage Rv0 through the side strip Rs. A parked vehicle Vs is present in the side strip Rs near a portion of the operation passage Rv0 which the towing tractor T enters. The parked vehicle Vs generates a blind spot in the detection range A21 of the vehicle sensor 21. In FIG. 3, a range of the blind spot of the vehicle sensor 21 is indicated by dot hatching. The bus B, which is the high-speed vehicle V, is present in the range of the blind spot of the vehicle sensor 21.

As described above, the grasping unit 41 grasps the presence or absence of an object around the towing tractor T based on the detection result of the vehicle sensor 21. However, the grasping unit 41 cannot grasp the presence or absence of an obstacle in the range of the blind spot of the vehicle sensor 21 in the surroundings of the towing tractor T. Therefore, the grasping unit 41 grasps the presence or absence of an obstacle by using the detection result of the detection unit 32 for the range of the blind spot of the vehicle sensor 21 in the surroundings of the towing tractor T.

The bus B present in the range of the blind spot of the vehicle sensor 21 is positioned within the detection range A31 of the outside sensor 31 of the detection device 11. Therefore, the detection unit 32 of the detection device 11 detects that an object is present in the detection passage Rd. The detection unit 32 discriminates that the type of the object is the high-speed vehicle V. The detection unit 32 detects the position of the object in the detection range A31 of the outside sensor 31. The detection device 11 transmits the detection result of the detection unit 32 to the grasping device 12 via the detection-side communication unit 33. The grasping device 12 receives the detection result of the detection unit 32 from the detection device 11 via the grasping-side communication unit 42. The grasping unit 41 grasps the position of the high-speed vehicle V in the airport from the position in the airport of the outside sensor 31 of the detection device 11 of the transmission source and the received detection result of the detection unit 32. Then, from the grasped position of the high-speed vehicle V in the airport, the grasping unit 41 grasps that the obstacle (high-speed vehicle V) is present in the range of the blind spot of the vehicle sensor 21 in the surroundings of the towing tractor T.

The vehicle controller 13 recognizes that the obstacle is present around the towing tractor T from a grasping result of the grasping unit 41. In this case, the vehicle controller 13 sets the traveling speed of the towing tractor T to zero, for example. That is, the vehicle controller 13 stops the towing tractor T. Upon recognizing that any obstacle is not present around the towing tractor T from the grasping result of the grasping unit 41, the vehicle controller 13 sets the traveling speed of the towing tractor T to a speed suitable for entering the operation passage Rv0.

For example, as illustrated in FIG. 4, the bus B, which is the high-speed vehicle V, makes a brief stop in the side strip Rs when passengers get on and off. The towing tractor T is traveling so as to approach the bus B stopped in the side strip Rs. The towing tractor T is traveling in a first lane Rv1, which is the lane closer to the side strip Rs, of the first lane Rv1 and a second lane Rv2 of the vehicle passage Rv. Thus, the first lane Rv1 is the lane closest to the side strip Rs, of the first lane Rv1 and a second lane Rv2 of the vehicle passage Rv.

The bus B is positioned within the detection range A31 of the outside sensor 31 of the detection device 11. Therefore, the detection unit 32 of the detection device 11 detects that an object is present in the detection passage Rd. The detection unit 32 discriminates that the type of the object is the high-speed vehicle V. The detection unit 32 detects the position of the object in the detection range A31 of the outside sensor 31. The detection device 11 transmits the detection result of the detection unit 32 to the grasping device 12 via the detection-side communication unit 33. The grasping device 12 receives the detection result of the detection unit 32 from the detection device 11 via the grasping-side communication unit 42. The grasping unit 41 grasps the position of the high-speed vehicle V in the airport from the position in the airport of the outside sensor 31 of the detection device 11 of the transmission source and the received detection result of the detection unit 32.

The vehicle controller 13 and the sensor controller 14 recognize that the high-speed vehicle V is stopped in the side strip Rs from the position of the high-speed vehicle V in the airport grasped by the grasping unit 41. The vehicle controller 13 and the sensor controller 14 recognize, from the position of the towing tractor T in the airport grasped by the grasping unit 41, that the towing tractor T is traveling so as to approach the high-speed vehicle V and that the towing tractor T is traveling in the first lane Rv1. The vehicle controller 13 recognizes, from the grasping result of the grasping unit 41, that any object is not present in the second lane Rv2, which is the lane farther from the side strip Rs than the first lane Rv1.

In this case, the vehicle controller 13 sets the traveling speed of the towing tractor T to a speed lower than the current speed. That is, the vehicle controller 13 decelerates the traveling speed of the towing tractor T. The vehicle controller 13 selects the second lane Rv2 as the traveling lane of the towing tractor T. That is, the vehicle controller 13 changes the lane of the towing tractor T. Furthermore, the sensor controller 14 sets the detection range A21 of the vehicle sensor 21 to a range wider than the current range indicated by the one-dot chain line in FIG. 4. Due to this, the vehicle sensor 21 performs detection in the detection range A21 indicated by the two-dot chain line in FIG. 4.

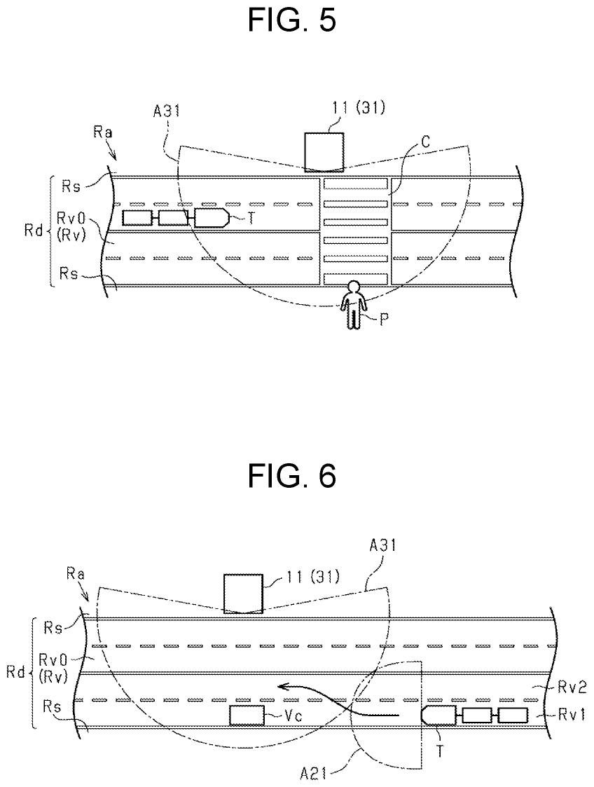

For example, as illustrated in FIG. 5, the person P is present near the pedestrian crossing C. The towing tractor T is traveling so as to approach the pedestrian crossing C.

The person P is positioned within the detection range A31 of the outside sensor 31 of the detection device 11. Therefore, the detection unit 32 of the detection device 11 detects that an object is present in the detection passage Rd. The detection unit 32 discriminates that the type of the object is the person P. The detection unit 32 detects the position of the object in the detection range A31 of the outside sensor 31. The detection device 11 transmits the detection result of the detection unit 32 to the grasping device 12 via the detection-side communication unit 33. The grasping device 12 receives the detection result of the detection unit 32 from the detection device 11 via the grasping-side communication unit 42. The grasping unit 41 grasps the position of the person P in the airport from the position in the airport of the outside sensor 31 of the detection device 11 of the transmission source and the received detection result of the detection unit 32.

The vehicle controller 13 recognizes that the person P is present near the pedestrian crossing C from the position of the person P in the airport grasped by the grasping unit 41. The vehicle controller 13 recognizes, from the position of the towing tractor T in the airport grasped by the grasping unit 41, that the towing tractor T is traveling so as to approach the pedestrian crossing C. In this case, the vehicle controller 13 sets the traveling speed of the towing tractor T to zero. That is, the vehicle controller 13 stops the towing tractor T.

For example, as illustrated in FIG. 6, the construction vehicle Vc is stopped in the first lane Rv1, which is the lane closer to the side strip Rs, of the first lane Rv1 and the second lane Rv2 of the vehicle passage Rv. The towing tractor T is traveling so as to approach the construction vehicle Vc. The towing tractor T is traveling in the first lane Rv1.

The construction vehicle Vc is positioned within the detection range A31 of the outside sensor 31 of the detection device 11. Therefore, the detection unit 32 of the detection device 11 detects that an object is present in the detection passage Rd. The detection unit 32 discriminates that the type of the object is the construction vehicle Vc. The detection unit 32 detects the position of the object in the detection range A31 of the outside sensor 31. The detection device 11 transmits the detection result of the detection unit 32 to the grasping device 12 via the detection-side communication unit 33. The grasping device 12 receives the detection result of the detection unit 32 from the detection device 11 via the grasping-side communication unit 42. The grasping unit 41 grasps the position of the construction vehicle Vc in the airport from the position in the airport of the outside sensor 31 of the detection device 11 of the transmission source and the received detection result of the detection unit 32.

The vehicle controller 13 recognizes that the construction vehicle Vc is present in the first lane Rv1 from the position of the construction vehicle Vc in the airport grasped by the grasping unit 41. The vehicle controller 13 recognizes, from the position of the towing tractor T in the airport grasped by the grasping unit 41, that the towing tractor T is traveling so as to approach the construction vehicle Vc and that the towing tractor T is traveling in the first lane Rv1. The vehicle controller 13 recognizes, from the grasping result of the grasping unit 41, that any object is not present in the second lane Rv2, which is the lane farther from the side strip Rs than the first lane Rv1. In this case, the vehicle controller 13 selects the second lane Rv2 as the traveling lane of the towing tractor T. That is, the vehicle controller 13 changes the lane of the towing tractor T.

### Functions and Effects of Present Embodiment

Functions and effects of the present embodiment will be described.

(1) The vehicle operation assist system 10 includes the plurality of detection devices 11 provided in the airport and the grasping device 12 provided in the towing tractor T. The detection devices 11 include the outside sensor 31, the detection unit 32, and the detection-side communication unit 33. The outside sensor 31 is installed such that the detection passage Rd is included in the detection range A31. The detection unit 32 detects the type of the object present in the detection passage Rd and the position of the object in the detection range A31 of the outside sensor 31 based on the detection result of the outside sensor 31. The detection unit 32 is configured to be able to discriminate the high-speed vehicle V as the type of the object. The detection-side communication unit 33 is configured to be able to transmit the detection result of the detection unit 32 to the grasping device 12. The grasping device 12 includes the grasping unit 41 and the grasping-side communication unit 42. The grasping unit 41 grasps the position of the towing tractor T in the airport, and grasps the presence or absence of an obstacle around the towing tractor T based on the detection result of the vehicle sensor 21. The grasping-side communication unit 42 is configured to be able to receive the detection result of the detection unit 32 transmitted from the detection-side communication unit 33. The grasping unit 41 grasps the position of the high-speed vehicle V in the airport from the position of the outside sensor 31 in the airport and the detection result of the detection unit 32.

According to this configuration, each of the plurality of detection devices 11 provided in the airport includes the detection unit 32 that detects the object present in the detection passage Rd. Thus, even if the detection range A21 of the vehicle sensor 21 has a blind spot, the grasping unit 41 can grasp the presence or absence of an obstacle in the range of the blind spot by using the detection result of the detection unit 32. Therefore, the presence or absence of an obstacle around the towing tractor T can be reliably grasped.

The detection unit 32 can discriminate the high-speed vehicle V as the type of the object. Thus, the grasping unit 41 can grasp the position of the high-speed vehicle V in the airport based on the detection result of the detection unit 32. Therefore, the positional relationship between the towing tractor T and the high-speed vehicle V in the airport can be grasped.

(2) The vehicle operation assist system 10 includes the vehicle controller 13 that controls travel of the towing tractor T. The vehicle controller 13 sets the traveling speed of the towing tractor T based on the positions of the towing tractor T and the high-speed vehicle V in the airport grasped by the grasping unit 41. For example, the vehicle controller 13 recognizes, from the positions of the towing tractor T and the high-speed vehicle V in the airport grasped by the grasping unit 41, that the towing tractor T is traveling so as to approach the high-speed vehicle V stopped in the side strip Rs. In this case, the vehicle controller 13 decelerates the traveling speed of the towing tractor T. This can reduce the risk that the towing tractor T comes into contact with the high-speed vehicle V. The high-speed vehicle V can smoothly enter the operation passage Rv0 from the side strip Rs. As a result, it becomes easy to achieve the punctual operation of the high-speed vehicle V.

(3) The vehicle operation assist system 10 includes the vehicle controller 13 that controls travel of the towing tractor T. The vehicle controller 13 selects the traveling lane of the towing tractor T based on the positions of the towing tractor T and the high-speed vehicle V in the airport grasped by the grasping unit 41. For example, the vehicle controller 13 recognizes, from the positions of the towing tractor T and the high-speed vehicle V in the airport grasped by the grasping unit 41, that the towing tractor T is traveling in the first lane Rv1, which is a lane closer to the side strip Rs than the second lane Rv2, and that the towing tractor T is traveling so as to approach the high-speed vehicle V stopped in the side strip Rs. In this case, by selecting the second lane Rv2, which is the lane farther from the side strip Rs than the first lane Rv1, as the traveling lane of the towing tractor T, the vehicle controller 13 changes the lane of the towing tractor T. This makes it easy to secure the distance between the towing tractor T and the high-speed vehicle V. The high-speed vehicle V can smoothly enter the operation passage Rv0 from the side strip Rs. As a result, it becomes easy to achieve the punctual operation of the high-speed vehicle V.

(4) The vehicle operation assist system 10 includes the sensor controller 14 that controls the vehicle sensor 21. The sensor controller 14 sets the detection range A21 of the vehicle sensor 21 based on the positions of the towing tractor T and the high-speed vehicle V in the airport grasped by the grasping unit 41. For example, the sensor controller 14 recognizes, from the positions of the towing tractor T and the high-speed vehicle V in the airport grasped by the grasping unit 41, that the towing tractor T is approaching the high-speed vehicle V stopped in the side strip Rs. In this case, the sensor controller 14 widens the detection range A21 of the vehicle sensor 21. This enables the grasping unit 41 to grasp the presence or absence of an object around the towing tractor T early. The detection range A21 of the vehicle sensor 21 when the towing tractor T is not approaching the high-speed vehicle V stopped in the side strip Rs is narrower than the detection range A21 of the vehicle sensor 21 when the towing tractor T is approaching the high-speed vehicle V stopped in the side strip Rs. Thus, in a situation where there is a low possibility that an obstacle is present around the towing tractor T, by narrowing the detection range A21 of the vehicle sensor 21, it is possible to reduce the load of processing related to grasping of the presence or absence of the obstacle around the towing tractor T.

(5) The vehicle operation assist system 10 includes the vehicle controller 13 that controls travel of the towing tractor T. The detection unit 32 of the detection device 11 with the detection range A31 of the outside sensor 31 including the pedestrian crossing C is configured to be able to discriminate the person P as the type of the object. The grasping unit 41 grasps the position of the person P in the airport from the position of the outside sensor 31 in the airport and the detection result of the detection unit 32. The vehicle controller 13 sets the traveling speed of the towing tractor T based on the positions of the towing tractor T and the person P in the airport grasped by the grasping unit 41.

According to this configuration, the detection unit 32 can also discriminate the person P as the type of the object. Thus, the grasping unit 41 can grasp the position of the person P in the airport based on the detection result of the detection unit 32. Therefore, the positional relationship between the towing tractor T and the person P in the airport can also be grasped.

The vehicle controller 13 sets the traveling speed of the towing tractor T based on the positions of the towing tractor T and the person P in the airport grasped by the grasping unit 41. For example, the vehicle controller 13 recognizes, from the positions of the towing tractor T and the person P in the airport grasped by the grasping unit 41, that the person P is present at the pedestrian crossing C or near the pedestrian crossing C and the towing tractor T is traveling so as to approach the pedestrian crossing C. In this case, the vehicle controller 13 stops the towing tractor T by setting the traveling speed of the towing tractor T to zero. This can reduce the risk that the towing tractor T comes into contact with the person P.

(6) The vehicle operation assist system 10 includes the vehicle controller 13 that controls travel of the towing tractor T. The detection unit 32 can discriminate the construction vehicle Vc as the type of the object. The grasping unit 41 grasps the position of the construction vehicle Vc in the airport from the position of the outside sensor 31 in the airport and the detection result of the detection unit 32. The vehicle controller 13 selects the traveling lane of the towing tractor T based on the positions of the towing tractor T and the construction vehicle Vc in the airport grasped by the grasping unit 41.

According to this configuration, the detection unit 32 can also discriminate the construction vehicle Vc as the type of the object. Thus, the grasping unit 41 can grasp the position of the construction vehicle Vc in the airport based on the detection result of the detection unit 32. Therefore, the positional relationship between the towing tractor T and the construction vehicle Vc in the airport can also be grasped.

The vehicle controller 13 selects the traveling lane of the towing tractor T based on the positions of the towing tractor T and the construction vehicle Vc in the airport grasped by the grasping unit 41. For example, the vehicle controller 13 recognizes, from the positions of the towing tractor T and the construction vehicle Vc in the airport grasped by the grasping unit 41, that the towing tractor T is traveling in the first lane Rv1, which is a lane closer to the side strip Rs than the second lane Rv2, and that the towing tractor T is traveling so as to approach the construction vehicle Vc present in the first lane Rv1. In this case, by selecting the second lane Rv2, which is the lane farther from the side strip Rs than the first lane Rv1, as the traveling lane of the towing tractor T, the vehicle controller 13 changes the lane of the towing tractor T. Thus, the towing tractor T can travel while avoiding the construction vehicle Vc. As a result, a smooth operation of the towing tractor T becomes possible.

(7) The outside sensor 31 of each of the detection devices 11 is a sensor that can perform detection in a wider range than that of the vehicle sensor 21 of each towing tractor T. Due to this, when the number of the towing tractors T used is relatively large, the cost required for grasping the presence or absence of the obstacle around the towing tractor T can be suppressed as compared with a case where the vehicle sensor 21 of each of the towing tractors T is a sensor that can perform detection in a relatively wide range.

(8) The plurality of detection devices 11 are installed such that parts of the detection ranges A31 of the outside sensors 31 of the adjacent detection devices 11 overlap. This can suppress detection omission of the object in the detection passage Rd.

### Modifications

The above-described embodiment can be implemented with the following modifications. The above-described embodiment and the following modifications can be implemented in combination with each other within a range not technically contradictory.
The vehicle operation assist system 10 does not need to include the vehicle controller 13.
The vehicle operation assist system 10 does not need to include the sensor controller 14.
The towing tractor T may be driven in a manned manner by a driver aboard the towing tractor T. In this case, the towing tractor T may have the following configuration.

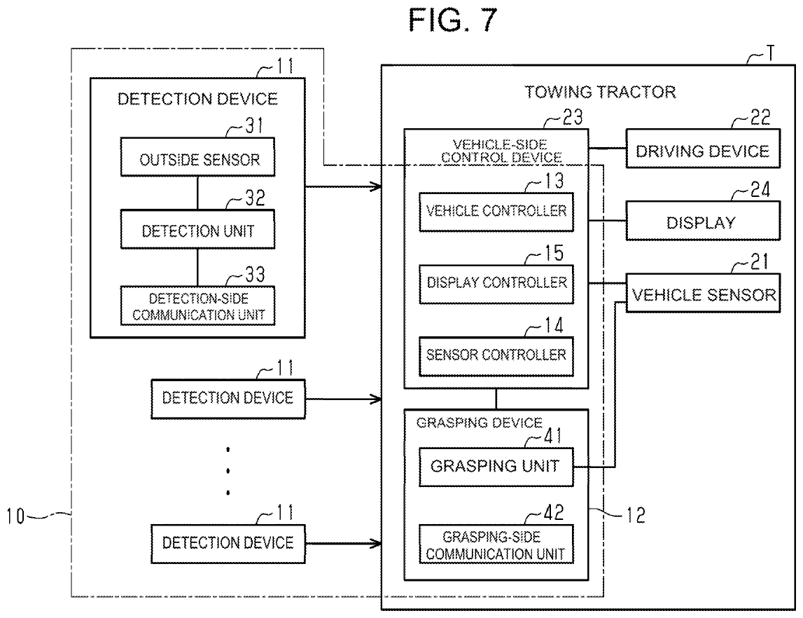

As illustrated in FIG. 7, the towing tractor T includes a display 24. The display 24 is provided at a position visually recognizable by the driver of the towing tractor T. The vehicle-side control device 23 includes a display controller 15 that controls display of the display 24. The display controller 15 is a part of the vehicle operation assist system 10.

The display controller 15 causes the display 24 to display the obstacle around the towing tractor T grasped by the grasping unit 41. Thus, by checking the display 24, the driver of the towing tractor T can easily recognize obstacles around the towing tractor T. This is particularly effective when the driver of the towing tractor T has a blind spot due to the parked vehicle Vs, a structure, or the like.

The display controller 15 may display, in a superimposed manner, the positions of an own vehicle and the high-speed vehicle V on a map in the airport by using the positions of the towing tractor T and the high-speed vehicle V in the airport grasped by the grasping unit 41. Then, the display controller 15 may cause the display 24 to display the map of the airport in which the positions of the own vehicle and the high-speed vehicle V are displayed in a superimposed manner. Thus, by checking the display 24, the driver of the towing tractor T can easily grasp the positional relationship between the own vehicle and the high-speed vehicle V. Therefore, the driver of the towing tractor T easily drives the towing tractor T so as not to disturb the operation of the high-speed vehicle V.

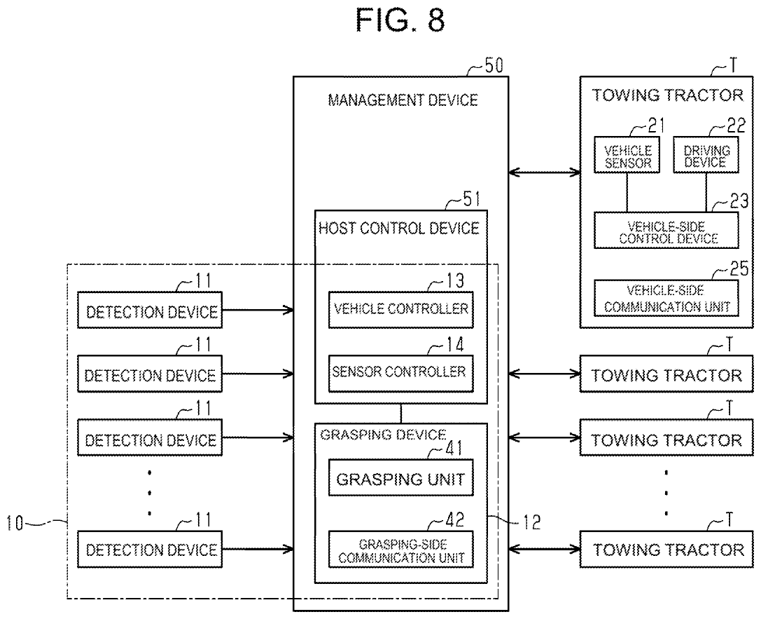

The driver may remotely operate the towing tractor T from a control room without boarding the towing tractor T. In this case, the display 24 and the display controller 15 are provided in the control room.
As illustrated in FIG. 8, a management device 50 may integrally manage a plurality of the towing tractors T. The management device 50 includes a host control device 51. The host control device 51 is a device similar to the vehicle-side control device 23. The grasping device 12 is provided in the management device 50. The grasping-side communication unit 42 can also communicate with a vehicle-side communication unit 25 provided in the towing tractor T in addition to the detection devices 11. The vehicle controller 13 and the sensor controller 14 are provided in the host control device 51.

In this case, the grasping unit 41 grasps the positions of the plurality of towing tractors T managed by the management device 50 as the positions of the towing tractors T in the airport.

The towing tractors T transmit the detection results of the vehicle sensors 21 to the management device 50 via the vehicle-side communication units 25. The management device 50 receives the detection results of the vehicle sensors 21 from the towing tractors T via the grasping-side communication unit 42. The grasping unit 41 grasps the presence or absence of an obstacle around the towing tractors T based on the received detection results of the vehicle sensors 21.

The vehicle controller 13 controls travel of the towing tractors T based on the grasping result of the grasping unit 41. For example, the vehicle controller 13 may set the traveling speed of the towing tractors T or select the traveling lane of the towing tractors T based on the positions of the plurality of towing tractors T grasped by the grasping unit 41. Similarly, the sensor controller 14 controls the vehicle sensors 21 based on the grasping result of the grasping unit 41. For example, the sensor controller 14 may set the detection ranges A21 of the vehicle sensors 21 based on the positions of the plurality of towing tractors T grasped by the grasping unit 41.

The management device 50 transmits the traveling speed of the towing tractors T set by the vehicle controller 13 to the towing tractors T via the grasping-side communication unit 42. The towing tractors T receive the traveling speed of the towing tractors T set by the vehicle controller 13 via the vehicle-side communication units 25. The vehicle-side control devices 23 control the driving devices 22 so that the traveling speed of the towing tractors T becomes the set speed.

The management device 50 transmits the traveling lane of the towing tractors T selected by the vehicle controller 13 to the towing tractors T via the grasping-side communication unit 42. The towing tractors T receive the traveling lane of the towing tractors T selected by the vehicle controller 13 via the vehicle-side communication units 25. The vehicle-side control devices 23 control the driving devices 22 so that the traveling lane of the towing tractors T becomes the selected lane.

The management device 50 transmits the detection ranges A21 of the vehicle sensors 21 set by the sensor controller 14 to the towing tractors T via the grasping-side communication unit 42. The towing tractors T receive the detection ranges A21 of the vehicle sensors 21 set by the sensor controller 14 via the vehicle-side communication units 25. The vehicle-side control devices 23 controls the vehicle sensors 21 such that the detection ranges A21 of the vehicle sensors 21 become within the set range.

The vehicle controller 13 may be provided not in the host control device 51 but in the vehicle-side control device 23. Similarly, the sensor controller 14 may be provided not in the host control device 51 but in the vehicle-side control device 23. In this case, the grasping device 12 transmits the grasping result of the grasping unit 41 to the towing tractor T via the grasping-side communication unit 42. The towing tractor T receives the grasping result of the grasping unit 41 via the vehicle-side communication unit 25. The vehicle controller 13 controls travel of the towing tractor T based on the received grasping result of the grasping unit 41. The sensor controller 14 controls the vehicle sensor 21 based on the received grasping result of the grasping unit 41.
The detection unit 32 does not need to be able to discriminate either the person P or the construction vehicle Vc as the type of the object, as long as it can discriminate the high-speed vehicle V as the type of the object.
The detection unit 32 may be able to discriminate objects of types other than the high-speed vehicle V, the person P, and the construction vehicle Vc.
The detection unit 32 may detect the weather in the airport based on the detection result of the outside sensor 31. The detection-side communication unit 33 transmits the weather in the airport to the grasping device 12 as a detection result of the detection unit 32. The grasping unit 41 grasps the weather in the airport by the grasping-side communication unit 42 receiving the detection result of the detection unit 32. The vehicle controller 13 may determine whether or not to operate the towing tractor T according to the weather in the airport grasped by the grasping unit 41. For example, when the weather in the airport grasped by the grasping unit 41 is bad weather such as snow or heavy rain, the vehicle controller 13 may interrupt the operation of the towing tractor T.
The vehicle controller 13 does not need to set the traveling speed of the towing tractor T based on the positions of the towing tractor T and the high-speed vehicle V grasped by the grasping unit 41.
The vehicle controller 13 does not need to set the traveling speed of the towing tractor T based on the positions of the towing tractor T and the person P grasped by the grasping unit 41.
The vehicle controller 13 does not need to select the traveling lane of the towing tractor T based on the positions of the towing tractor T and the high-speed vehicle V grasped by the grasping unit 41.
The vehicle controller 13 does not need to select the traveling lane of the towing tractor T based on the positions of the towing tractor T and the construction vehicle Vc grasped by the grasping unit 41.
The sensor controller 14 does not need to set the detection range A21 of the vehicle sensor 21 based on the positions of the towing tractor T and the high-speed vehicle V grasped by the grasping unit 41.
The vehicle sensor 21 is not limited to the LIDAR. The vehicle sensor 21 may be another type of sensor as long as the grasping unit 41 can grasp the presence or absence of the obstacle around the towing tractor T based on the detection result of the vehicle sensor 21. The vehicle sensor 21 may be, for example, a camera.
The outside sensor 31 is not limited to the LIDAR. The outside sensor 31 may be another type of sensor as long as the detection unit 32 can discriminate the type of the object in the airport passage Ra based on the detection result of the outside sensor 31. The outside sensor 31 may be, for example, a camera.
The plurality of detection devices 11 do not need to be installed such that parts of the detection ranges A31 of the outside sensors 31 of the adjacent detection devices 11 overlap.
The detection device 11 may also be installed in a passage other than the detection passage Rd.

What is claimed is:

1. A vehicle operation assist system for use in an airport where a towing tractor mounted with a vehicle sensor and a high-speed vehicle that is a vehicle having a speed limit set to be higher than a speed limit of the towing tractor operate, the vehicle operation assist system comprising:
a plurality of detection devices provided in the airport; and
a grasping device provided in the towing tractor or a management device that manages an operation of the towing tractor, wherein
the detection devices include
an outside sensor provided outside the towing tractor, the outside sensor being installed such that a detection passage including an operation passage where the towing tractor and the high-speed vehicle operate and side strips provided on both sides of the operation passage is included in a detection range,
a detection unit that detects a type of an object present in the detection passage and a position of the object in the detection range of the outside sensor based on a detection result of the outside sensor, and
a detection-side communication unit that is configured to transmit a detection result of the detection unit to the grasping device,
the grasping device includes
a grasping unit that grasps a position of the towing tractor in the airport and grasps presence or absence of an obstacle around the towing tractor based on the detection result of the vehicle sensor, and
a grasping-side communication unit that is configured to receive the detection result of the detection unit transmitted from the detection-side communication unit,
the detection unit is configured to discriminate the high-speed vehicle as the type of the object, and
the grasping unit grasps a position of the high-speed vehicle in the airport from a position of the outside sensor in the airport and the detection result of the detection unit.

2. The vehicle operation assist system according to claim 1, further comprising:
a vehicle controller that is provided in the towing tractor or the management device and controls travel of the towing tractor, wherein
the vehicle controller sets a traveling speed of the towing tractor based on positions of the towing tractor and the high-speed vehicle in the airport grasped by the grasping unit.

3. The vehicle operation assist system according to claim 1, further comprising:
a vehicle controller that is provided in the towing tractor or the management device and controls travel of the towing tractor, wherein
the vehicle controller selects a traveling lane of the towing tractor based on positions of the towing tractor and the high-speed vehicle in the airport grasped by the grasping unit.

4. The vehicle operation assist system according to claim 1, further comprising:
a sensor controller that is provided in the towing tractor or the management device and controls the vehicle sensor, wherein
the sensor controller sets the detection range of the vehicle sensor based on positions of the towing tractor and the high-speed vehicle in the airport grasped by the grasping unit.

5. The vehicle operation assist system according to claim 1, further comprising:
a vehicle controller that is provided in the towing tractor or the management device and controls travel of the towing tractor, wherein
the detection unit of the detection devices with the detection range of the outside sensor including a pedestrian crossing is configured to discriminate a person as the type of the object,
the grasping unit grasps a position of the person in the airport from a position of the outside sensor in the airport and the detection result of the detection unit, and
the vehicle controller sets a traveling speed of the towing tractor based on positions of the towing tractor and the person in the airport grasped by the grasping unit.
